(19) United States
(12) Patent Application Publication
(10) Pub. No.: US 2008/0144025 A1
(43) Pub. Date: Jun. 19, 2008

(54) Apparatus for wafer inspection

(75) Inventors: Wolfgang Vollrath, Burbach (DE); Alexander Buettner, Wetzlar (DE); Christof Krampe-Zadler, Castrop-Rauxel (DE)

Correspondence Address: Davidson, Davidson & Kappel, LLC, 485 7th Avenue, 14th Floor, New York, NY, 10018, US

(73) Assignee: Vistec Semiconductor Systems GmbH, Weilburg (DE)

(21) Appl. No.: 11/999,611

(22) Filed: Dec. 6, 2007

(30) Foreign Application Priority Data
Dec. 15, 2006 (DE) 102006059190.9-52

(51) Int. Cl. G01J 3/00

(52) U.S. Cl. 356/300

(57) ABSTRACT

An apparatus for inspecting a wafer, comprising at least one illuminator each arranged in an illumination beam path, wherein the at least one illuminator radiates an illumination spot onto a surface of the wafer and being a continuous light source; a detector arranged in a detection beam path has a predetermined spectral sensitivity and records data from the at least one illumination spot from the surface of the wafer; an imager generating a relative movement between the surface of the wafer and the detector, whereby in a meandering movement the illumination spot is passed across the entire surface of the wafer in the scanning direction; and the at least one illumination spot being detected in a plurality of different spectral ranges.

This claims the benefit of German Patent Application No. DE 10 2006 059 190.9, filed on Dec. 15, 2006 and hereby incorporated by reference herein.

The present invention relates to an apparatus for wafer inspection. In particular, the present invention relates to an apparatus for the inspection of a wafer, including at least one illumination device for radiating an illumination light beam in an illumination beam path onto a surface of the wafer. Further, a detector is provided, which determines a detection beam path and has a predetermined spectral sensitivity. The detector records data of at least one illuminated area on the surface of the wafer. Herein the light coming from the surface of the wafer can have a plurality of different spectral ranges.

### BACKGROUND

To improve quality and efficiency in the manufacture of integrated circuits, apparatus for detecting macro defects on the surface of wafers are used, so that wafers found to be defective can be rejected or post-processed until the quality of a currently inspected wafer is sufficient.

Optical inspection apparatus are known, which radiate an illumination light beam by means of an illumination device onto a surface of the wafer. An image recording means is also provided to detect an image or data from the illuminated area on the surface of the wafer in a plurality of spectral ranges, i.e. spectrally resolved. Herein, there can be problems with the further processing of the color signals detected by the image detector if the color image channels of the image detector are driven in an irregular fashion, which can result in relatively low signal to noise ratio or to overdriving in the individual color signals.

German patent application publication DE 101 32 360 discloses an apparatus for the color neutral brightness adjustment in the illumination beam path of a microscope. The invention is based on the idea that with microscopes operated with an incandescent lamp similar to a black light, the color temperature of the color spectrum emitted by the incandescent lamp is shifted from the blue spectral range to the red spectral range when the input lamp power is reduced. To compensate the red shift a variable optical filter is provided in the illumination beam path having a variable transmission for red light across the filter area. By displacing the filter in the illumination beam path, a blue shift is caused, which is compensated by the red shift caused by the reduction of the electric power.

German patent application publication DE 100 31 303 discloses an illumination apparatus having LEDs. Due to the degradation of the LED material, the intensity and wave length of the light emitted by the LED changes over time. In order to achieve uniform illuminating characteristics, a feedback control is provided so that a predetermined color temperature and intensity of the LEDs can be maintained.

U.S. Pat. No. 6,847,443 B1 discloses a system and a method for detecting surface defects by means of light that has a plurality of wavelengths with narrow band widths. The defects primarily occur in surface structures formed on the surface of a semiconductor wafer. A light source, preferably a flash lamp light source, is provided, which supplies the illumination light. The illumination light is divided into a plurality of selected bands having respective bandwidths by means of a filter. The light is then transferred to a diffuser by means of an optical fiber, and from there the light is directed onto the surface of a semiconductor wafer. A camera receives a plurality of images, wherein each image has been produced from a different section of the spectrum. The images can be generated both by reflected and diffracted light. The images can be stored or compared with the image of a calibration wafer. The small bandwidth of the illumination light is chosen such that the wavelength of the illumination light is in the range of maximum sensitivity of each camera channel. By comparing the measured light intensities with the light intensities measured on a defect free wafer, the contrast values can be determined for each area of the wafer surface. It has been shown that the larger the defect, the greater the contrast value. The narrow band illumination and the associated narrow band detection result in the contrast being substantially improved. However, this principle is not sufficient to further improve the detection speed and the detection sensitivity.

### SUMMERY OF THE INVENTION

An object of the present invention is to provide an apparatus, with which the detection speed and the detection sensitivity can be further improved.

The present invention provides an apparatus with at least one illumination device each arranged in an illumination beam path, wherein the at least one illumination device radiates an illumination spot onto a surface of the wafer and being a continuous light source. A detector is arranged in a detection beam path and has a predetermined spectral sensitivity. The detector records data from the at least one illumination spot from the surface of the wafer. An imager generates a relative movement between the surface of the wafer and the detector, whereby in a meandering movement the illumination spot is passed across the entire surface of the wafer in the scanning direction. The at least one illumination spot is detected in a plurality of different spectral ranges.

According to the present invention, an apparatus for inspecting the surface of a wafer is provided, the illumination device of which includes at least one continuous light source. In another embodiment, a polarizer is downstream of the illumination device in the illumination beam path.

The illumination device can include a light source which emits light having a plurality of discretely formed intensity peaks at different wavelengths. Moreover, the illumination device may include a continuously adjustable light source so that each required wavelength range can be set. It goes without saying that the spectral width of the wavelength range required can be adapted to the requirements needed for the inspection.

The illumination device can further include an LED illumination. The illumination device can also be provided as a broad band light source, wherein the individual wavelengths or wavelength ranges, are adjustable by means of corresponding filters.

The detector can be configured as a line camera. It is also conceivable that the detector includes a trilinear detector, wherein the individual lines of the trilinear detector are each provided with a suitable wavelength filter. Moreover, the detector can include three light-sensitive chips arranged around a prism arrangement in such a way, that each of the chips receives a different wavelength. The detector may also include a two-dimensional light-sensitive chip having a dispersive element upstream of it which directs the different wavelength ranges onto different areas of the light-sensitive chip. This detector can be regarded as an imaging spectrometer.

According to an embodiment of the present invention, a beam splitter is provided for making the light of the illumination device collinear with the detection beam path of the detector. The beam splitter used here can include polarizing characteristics.

In a further embodiment of the present invention, the illumination device and the detector are arranged such that the illumination beam path and the detection beam path are each inclined at an angle to the normal on the surface of the wafer. The inclined arrangement of the illumination device and the detector can be provided in a bright-field arrangement, which means that the angles at which the illumination beam path and the detection beam path are inclined to the normal on the surface of the wafer are equal. In the dark field arrangement, the angle at which the illumination beam path is inclined to the normal on the surface of the wafer differs from that at which the detection beam path is inclined.

In another embodiment of the present invention, a first and a second illumination device, and a first and a second detector are provided. The illumination devices each include a continuous light source, and in the illumination beam path of at least one of the illumination devices, a polarizer may be provided in a further embodiment.

The first detector can be configured to be monochromatic, for example, so that the detection has high resolution. The second detector can be polychromatic, for example, and has a lower resolution than the first detector.

It is advantageous if a polarizer is arranged in at least one of the illumination beam paths. In addition, with grating-type structures (so-called zero order gratings) the orientation of the grating relative to the polarization direction can be determined. It is also possible to determine in this way whether or not (and if necessary where) there are grating structures on the wafer. This cannot be achieved with the usual rather low resolution in the range of >5 μm in current macro inspection. If the grating period of the structures present on the wafer is in the area of a few illumination wavelengths and less, use of the present invention is particularly advantageous.

### BRIEF DESCRIPTION OF THE DRAWINGS

FIG. 1 is a schematic view of a system for detecting defects on wafers, or structured semiconductor substrates;

FIG. 2 is a schematic representation of the arrangement of the illumination device and the detector for the apparatus according to the present invention;

FIG. 3 is a schematic representation of an embodiment of the arrangement of the illumination device and the detector, wherein the polarizer is arranged in the illumination beam path;

FIG. 4 shows another embodiment of the present invention which shows the arrangement of the illumination device and the detector;

FIG. 5 is a schematic representation of a further embodiment of the present invention, wherein the illumination device and the detector are arranged at an angle to each other;

FIG. 6 is a schematic representation showing how the whole surface area of a wafer, or a structured semiconductor component, is detected with the apparatus according to the present invention;

FIG. 7a shows a detailed view of the arrangement, wherein the detector includes a trilinear detector;

FIG. 7b shows another embodiment of the detector, wherein the detector includes a plurality of detector chips;

FIG. 7c shows an embodiment of the detector, wherein the detector includes a two dimensional detector chip;

FIG. 8a is a schematic representation of an embodiment of the arrangement of the illumination device and the detector, wherein a DMD is arranged in the illumination beam path;

FIG. 8b is a schematic representation of a possible illumination pattern created by means of the DMD on the surface of the wafer;

FIG. 9 is a representation of the light emitted by a line light source;

FIG. 10 is a representation of the intensity characteristic of a continuously adjustable light source;

FIG. 11 is a representation of the intensity characteristic of the light emitted by an LED;

FIG. 12 is a schematic representation of the acquisition of corresponding spectral illumination bands, wherein the light source used is a broad band light source.

### DETAILED DESCRIPTION

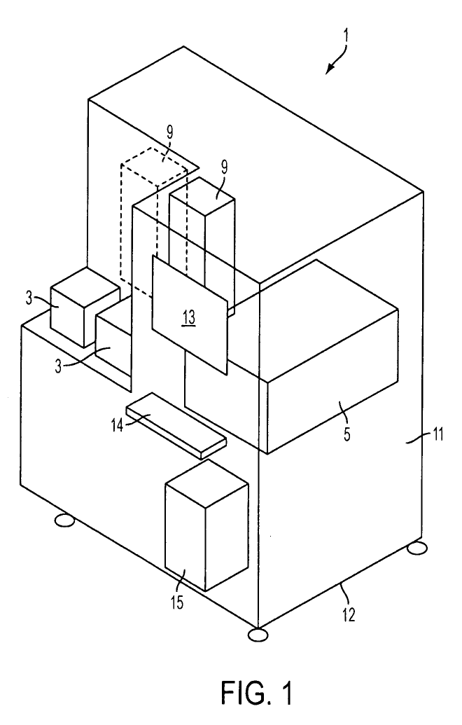

FIG. 1 shows a system for inspecting structures on semiconductor substrates. System 1 includes the present invention in its interior. System 1 consists, for example, of at least one cartridge element 3 for the semiconductor substrates or wafers. Images, image data or data of the individual wafers or structured semiconductor substrates are recorded in a measuring unit 5. A transfer mechanism 9 is provided between cartridge element 3 for the semiconductor substrates or wafers and measuring unit 5. The system itself is enclosed in a housing 11, wherein housing 11 defines a base area 12. Further, at least one computer is integrated in system 1, which is for evaluating or processing the individual image data. System 1 is provided with a display 13 and a keyboard 14. The user can make data inputs for controlling the system or even parameter inputs for evaluating the recorded data, image data or images from the individual wafers, using keyboard 14. A plurality of user interfaces is shown to the user of system 1 on display 13. In addition, information on the current measurement is shown to the user on the user interface. System 1 can further have a modular structure so that further measuring means (not shown) can be added to system 1. The further measuring means are then usable for different inspection methods.

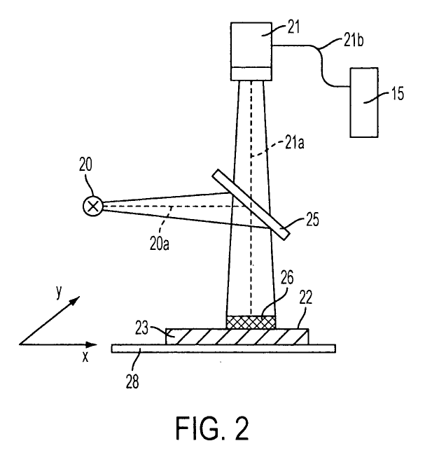

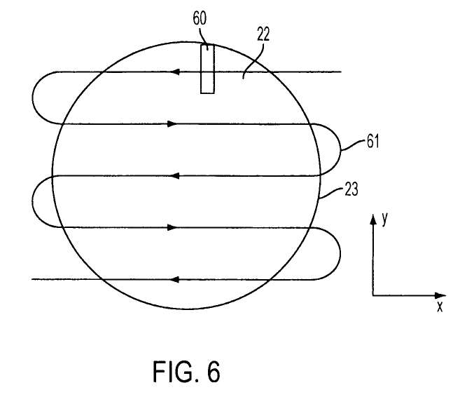

FIG. 2 shows an embodiment of the present invention. The apparatus comprises an illumination device 20 defining an illumination beam path 20a. The apparatus further includes a detector 21 also defining a detection beam path 21a. A beam splitter 25 having polarizing characteristics is also provided for making illumination beam path 20a collinear with detection beam path 21a. Beam splitter 25 therefore directs the light emitted by illumination device 20 onto surface 22 of wafer 23. The light emitted or reflected by surface 22 of wafer 23 passes along detection beam path 21a to detector 21. It should also be noted that beam splitter 25 is arranged in such a way that the light emitted by illumination device 20 impinges essentially vertical on the surface of the wafer. The light of illumination device 20 illuminates an area 26 on surface 22 of wafer 23. As a result, only currently illuminated area 26 of surface 22 of wafer 23 is detected by detector 21. Wafer 23 (or the semiconductor substrate) is placed on a support means 28 which is configured to be moveable. Support means 28 can be configured, for example, to be rotatable or displaceable in two orthogonal directions in space, such as in the x and y coordinate directions. By providing this displacement facility, it is possible to detect the whole surface 22 of wafer 23 with the apparatus of the present invention. A detailed description of the method for scanning the surface 22 of wafer 23 will be given with reference to FIG. 6.

With reference to FIG. 2, the detector 21 is connected to computer 15, which serves as a data readout means, via data line 21b, for reading out and evaluating or latching the detected data. The data readout means is configured and adapted in such a way that continuous scanning of surface 22 of wafer 23 is possible with a continuous light source. Herein, the readout rate of the data readout means must be synchronized with the displacement speed of imager 28 for wafer 23.

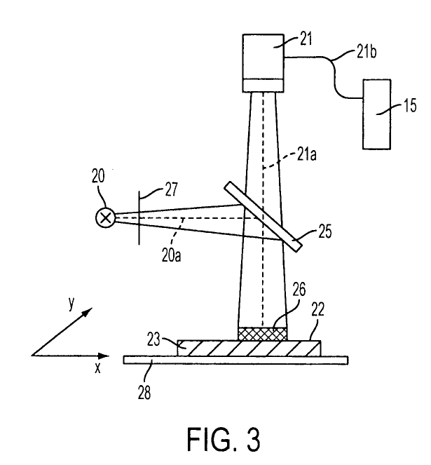

FIG. 3 is a schematic representation of an embodiment of the arrangement of the illumination device 20 and detector 21, wherein a polarizer 27 is arranged in illumination beam path 20a. The at least one polarizer 27 is provided between illumination device 20 and beam splitter 25. The resolution of the apparatus according to the present invention can be enhanced with this polarizer 27. Otherwise, this apparatus includes the same features as the apparatus shown with reference to FIG. 2.

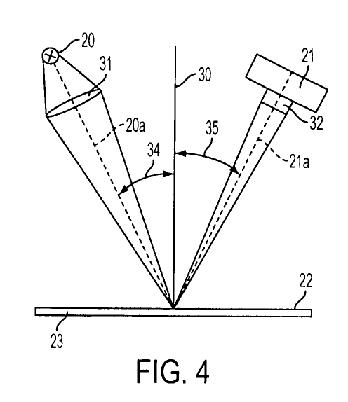

FIG. 4 shows another embodiment of the apparatus according to the present invention which is suitable for the high resolution inspection of surface 22 of a wafer 23. Illumination device 20 and detector 21 are arranged inclined at a small angle 34 with respect to the normal 30 on surface 22 of wafer 23. In this arrangement, illumination beam path 20a forms a small angle 34 with normal 30, which is perpendicular to surface 22 of wafer 23. Detector 21 is also arranged in such a way that detection beam path 21a defined by detector 21 is also inclined at a small angle 35 to normal 30. In illumination beam path 20a, an optics, or a lens 31 is arranged, which forms the light emitted by illumination device 20 and images it as a narrow line or a correspondingly formed light spot on surface 22 of wafer 23. A polarizer 27 can be additionally arranged downstream of lens 31. Polarizer 27 is not necessarily required for the present invention. Polarizer 27 is for enhancing the contrast of the recording of the image data by detector 21. The light reflected or emitted by surface 22 of wafer 23 also passes via an optics 32 to detector 21 and is analyzed and registered there in a suitable way.

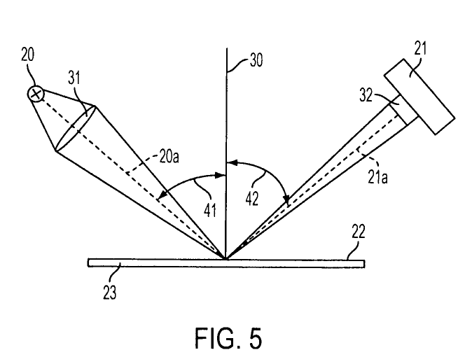

FIG. 5 again illustrates the variable arrangement of illumination device 20 and detector 21. In the arrangement shown in FIG. 5, illumination beam path 20a is inclined with respect to detection beam path 21a by an angle 41 or an angle 42 with respect to normal 30 on the surface of wafer 23. If angle 41 is equal to angle 42, this is referred to as a bright-field arrangement. If angle 41 is not equal to angle 42, this is referred to as a dark-field arrangement. This has the particular advantage that the user can switch between the two arrangements according to his measuring problem. In one case, the bright-field arrangement may be better suited for solving a measuring problem than the dark-field arrangement, and vice versa.

FIG. 6 shows how the detection or scanning of the entire surface 22 of a wafer 23 is carried out. The at least one illumination device 20 creates an illumination spot 60 on surface 22 of wafer 23, when only one illumination device is provided. Illumination spot 60 can also result from overlapping two or more illumination fields from a plurality of illumination devices. Illumination spot 60 can be configured as a line, a small area, an area of any particular shape, or as a symmetric area. If the illumination spot 60 is a line, the length of illumination spot 60 is greater than its width. Illumination spot 60 is guided along a meandering line 61, by moving wafer 23 in the x direction (scanning direction 63, see arrow) and the y direction, in order to scan the entire surface 22 of wafer 23.

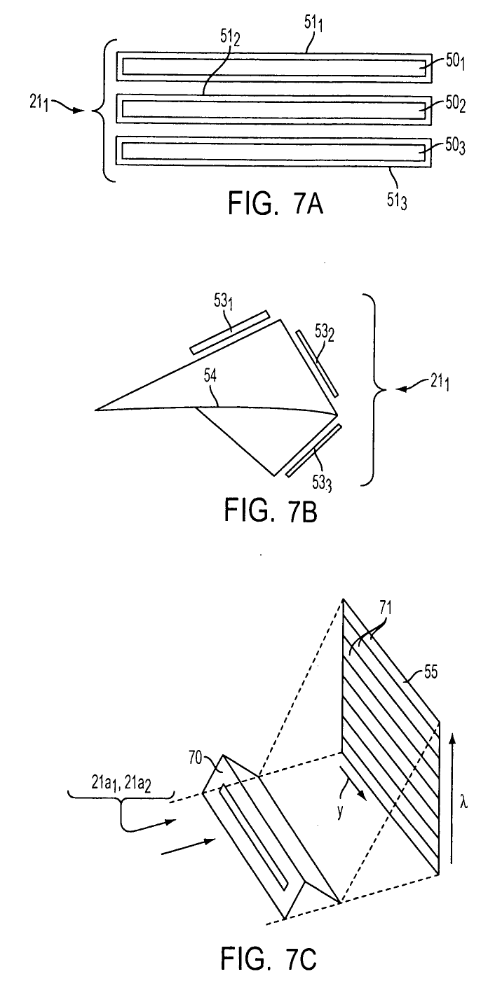

FIG. 7a is a detail view of the arrangement, wherein the detector includes a trilinear detector. Detectors 21₁ or 21₂ includes three detector lines 50₁, 50₂ and 50₃, each of which is provided with a corresponding color filter 51₁, 51₂ and 51₃. Using the trilinear detector, it is therefore possible for each of the detector lines 50₁, 50₂ and 50₃ to detect the light information from surface 22 of wafer 23 in a different color, depending on the embodiment of color filters or wavelength filters 51₁, 51₂ and 51₃.

FIG. 7b shows another embodiment of detector 21₁ and/or 21₂, wherein the detector includes a plurality of detector chips 53₁, 53₂ and 53₃. Detector chips 53₁, 53₂ and 53₃ are arranged around a dispersive arrangement 54, for spectrally splitting the impinging light, so that the individual detector chips 53₁, 53₂ and 53₃ each receive different color information. In a particular embodiment, first detector chip 53₁ can detect red light, second detector chip 53₂ can detect green light and third detector chip 53₃ can detect blue light.

FIG. 7c shows an embodiment of detector 21₁ and/or 21₂, wherein the detector includes a two-dimensional detector chip 55. In the present case, a dispersive element 70 is arranged in second detection beam path 21a₁ or 21a₂. Dispersive element 70 is for spatially separating the spectral portions of the detected light in detection beam path 21a₁ or 21a₂, so that the detected light can be imaged onto the individual detector lines 71 of detector chip 55 in a spectrally split manner. A lens (not shown) can be arranged downstream of dispersive element 70, which images the spatially split light in a suitable way onto the individual detector lines 71 of two-dimensional detector chip 55. The exemplary embodiment shown here is an imaging spectrometer.

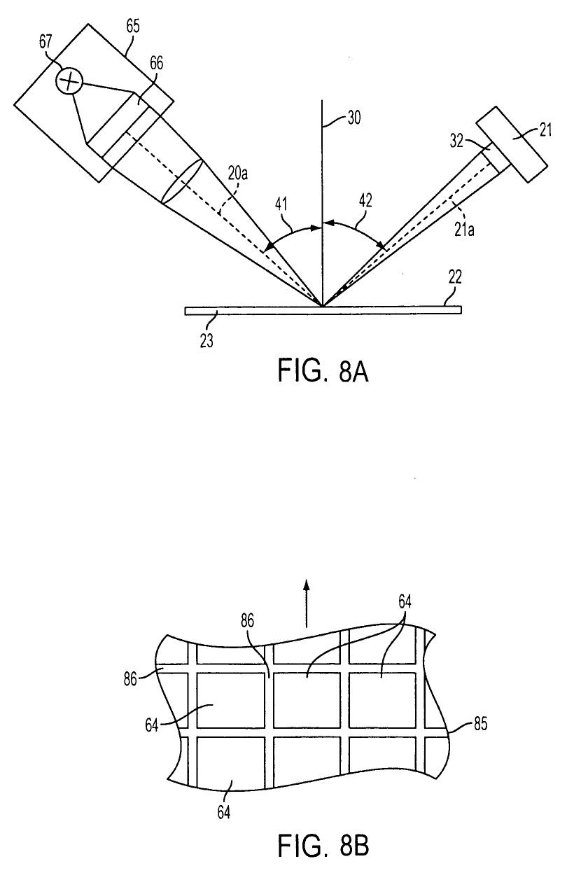

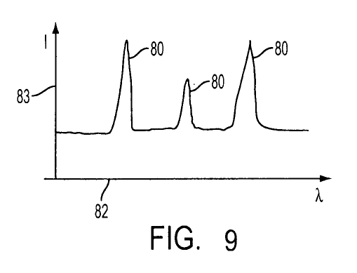

FIG. 8a is a schematic representation of another embodiment of illumination device 65 in illumination beam path 20₁. Illumination device 65 includes a digital modulator 66 (DMD) in illumination beam path 20₁ of light source 67. Illumination device 65 is arranged in an illumination beam path 20a. In the arrangement shown in FIG. 9a, illumination beam path 20a is inclined with respect to detection beam path 21a, by an angle 41 or an angle 42, respectively, with respect to normal 30 on surface 22 of wafer 23. If angle 41 is equal to angle 42, this is referred to as a bright-field arrangement. If angle 41 is not equal to angle 42, this is referred to as a dark-field arrangement. The present embodiment has the particular advantage that the user can switch between the two arrangements according to the measuring problem. In one case, the bright-field arrangement may be better suited for solving a measuring problem than the dark-field arrangement, and vice versa.

FIG. 8b is a schematic representation of a possible illumination pattern 85, which can be created with the aid of DMD 66 on surface 22 of wafer 23. In FIG. 9b an illumination pattern 85 is shown which takes dies 64 arranged on surface 22 of wafer 23 into account. Illumination pattern 85 can also be configured in such a way, for example, that areas 86, the so-called “streets” between dies 64, are illuminated with a different intensity to the dies 64 themselves. It is also conceivable, that the areas of illumination pattern 85 may differ from each other with respect to their wavelengths and/or their intensities.

FIG. 9 shows the spectral composition of the illumination light when illumination device 20 is configured as a spectral line light source. In FIG. 7, abscissa 82 is the wavelength λ, and ordinate 83 is the intensity I. It can be quite easily seen that the spectral line light source shows different peaks 80, differing from each other in wavelength λ. It is obvious from the peaks formed with the spectral line light source that surface 22 of wafer 23 is spectrally illuminated.

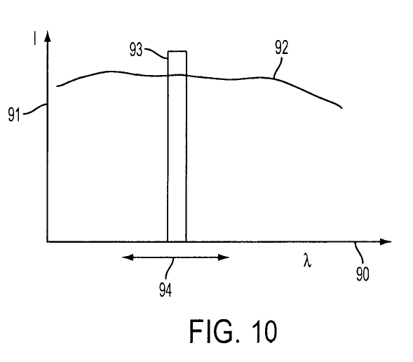

In FIG. 10, again, abscissa 9 is wavelength λ, and ordinate 91 is the intensity. The continuously adjustable light source shows an intensity characteristic 92, essentially independent of wavelength λ. The continuously adjustable light source is controlled in such a way that a wavelength range or wavelength peak 93 selected by the user is emitted. Surface 22 of wafer 23 can then be illuminated with this wavelength peak 93 or this spectral interval.

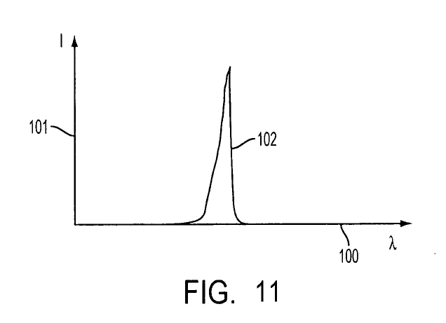

FIG. 11 shows the intensity of the illumination, when illumination device 20 is configured as an LED. Again, abscissa 100 is the wavelength λ and ordinate 101 is the intensity. When only one type of LED is used an excellent peak 102 can be seen at wavelength λ. The surface of the wafer is then illuminated by this intensity peak. It goes without saying that LEDs may also be used which emit light at different wavelengths. It is obvious, that in the diagram of FIG. 10 a plurality of intensity peaks would then be discernible at different wavelengths.

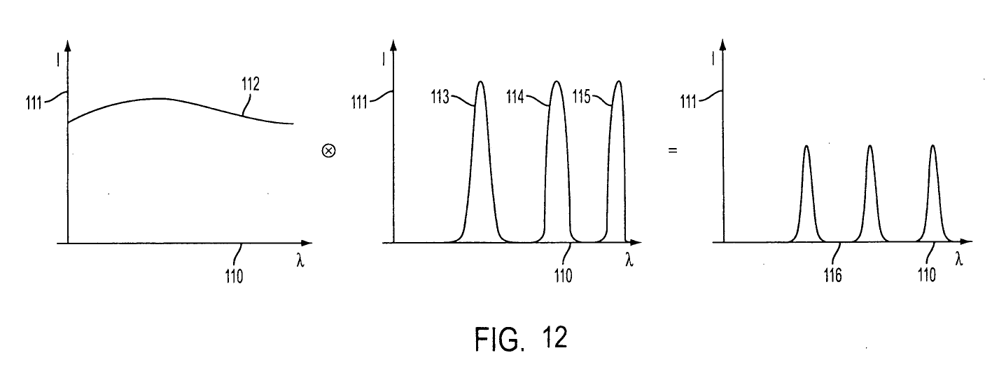

FIG. 12 shows a broadband light source used with a filter, preferably a comb filter. First the broadband light source emits light which is essentially independent of wavelength λ. This is shown in FIG. 11a. In the figure, abscissa 110 is the wavelength λ, and ordinate 111 is the intensity I. The comb filter has the effect that light is transmitted only in a narrow wavelength range. As shown in FIG. 11b, in which, abscissa 110 is the wavelength λ, and ordinate 111 is the intensity I, the comb filter produces strong wavelength peaks at different wavelengths. The result of the broadband light source in combination with the comb filter is shown in FIG. 11c. Again, abscissa 110 is the wavelength λ, and ordinate 111 is the intensity I. When a three-band comb filter is used, the final result from the broadband light source, is a light characterized by three corresponding different wavelength peaks at different wavelengths.

While the present invention was described with respect to a particular embodiment, it is obvious to the person skilled in the art that modifications and changes to the invention can be made without departing from the scope of the appended claims.

1. An apparatus for inspecting a wafer, comprising:
at least one illuminator each arranged in an illumination beam path, wherein the at least one illuminator radiates an illumination spot onto a surface of the wafer and being a continuous light source;
a detector arranged in a detection beam path has a predetermined spectral sensitivity and records data from the at least one illumination spot from the surface of the wafer;
an imager generating a relative movement between the surface of the wafer and the detector, whereby in a meandering movement the illumination spot is passed across the entire surface of the wafer in the scanning direction; and
the at least one illumination spot being detected in a plurality of different spectral ranges.

2. The apparatus according to claim 1, wherein a polarizer is arranged downstream of the at least one illuminator in each illumination beam path.

3. The apparatus according to claim 1, wherein a digital modulator is arranged downstream of the at least one illuminator forming an illuminated field on the surface of the wafer, the surface of the wafer having an illumination pattern creating areas on the surface of the wafer locally differing from each other with respect to wavelengths and/or intensities of the areas.

4. The apparatus according to claim 1, wherein the illuminator includes a light source emitting light having a plurality of discreetly formed intensity peaks at different wavelengths.

5. The apparatus according to claim 1, wherein the illuminator is a continuously adjustable light source so that each required wavelength range can be adjusted.

6. The apparatus according to claim 1, wherein the illuminator includes at least one LED.

7. The apparatus according to claim 1, wherein the illuminator is a broadband light source, the individual wavelengths or wavelength ranges being adjustable using corresponding filters.

8. The apparatus according to claim 1, wherein the detector is a line camera.

9. The apparatus according to claim 1, wherein the detector includes a trilinear detector, wherein the individual lines of the trilinear detector are provided with a suitable wavelength filter.

10. The apparatus according to claim 1, wherein the detector includes three light-sensitive detector chips arranged around a dispersive arrangement in such a way that each of the detector chips receives a different wavelength.

11. The apparatus according to claim 1, wherein the detector includes a two-dimensional light-sensitive detector chip having a dispersive element arranged upstream of the detector chips for directing the different wavelength ranges onto different detector lines of the light-sensitive detector chip

12. The apparatus according to claim 1, further comprising a beam splitter for making a light of the illuminator collinear with the detection beam path of the detector.

13. The apparatus according to claim 12, wherein the beam splitter has polarizing characteristics.

14. The apparatus according to claim 1, wherein the illuminator and the detector are arranged in such a way that the illumination beam path and the detection beam path are each inclined at an angle to a normal on the surface of the wafer.

15. The apparatus according to claim 14, wherein the angle of the illumination beam path and the detection beam path is adjustable.

16. The apparatus according to claim 1, wherein the at least one illuminator creates spatially separate illumination fields on the surface of the wafer in the scanning direction.
